(19) United States
(12) Patent Application Publication
(10) Pub. No.: US 2020/0171555 A1
(43) Pub. Date: Jun. 4, 2020

(54) BALL CIRCULATION PUMP SKID AND RELATED METHOD

(71) Applicant: OVIVO INC., MONTREAL (CA)

(72) Inventors: Jacob C. Himebaugh, South Jordan, UT (US); Trevor R. Auman, Sandy, UT (US)

(21) Appl. No.: 16/209,138

(22) Filed: Dec. 4, 2018

(51) Int. Cl. B08B 9/057; B08B 3/10; B08B 9/032

(52) U.S. Cl. CPC B08B 9/057; B08B 2209/053; B08B 9/032; B08B 3/10

(57) ABSTRACT

A ball circulation pump skid includes a piping manifold mounted to a base frame, having a first inlet and a first outlet each connected to a pump, and provided with a second inlet and a second outlet connectable to an external device. The manifold houses a ball collection capsule configured to permit flow of fluid and entrained cleaning balls into the ball collection capsule in a first flow direction and to permit flow of fluid and entrained cleaning balls out of the ball collection capsule in a second flow direction. Valves mounted to the piping manifold are operative to create alternately a first fluid flow path and a second fluid flow path through the piping manifold, to capture the cleaning balls in the collection capsule prior to fluid flow to the pump and to re-entrain the cleaning balls prior to fluid delivery to the external device.

### BACKGROUND OF THE INVENTION

This invention relates to a ball circulation pump skid. Such a pump skid includes rubber cleaning balls that travel with fluid circulating through a hydraulic circuit for cleaning the internal surfaces of the piping and the devices incorporated into the circuit.

Current ATCS (auto tube cleaning system) ball circulation pump skids require the cleaning balls to travel through the circulation pump during both the circulation and collection cycles. To prevent damage to the cleaning balls during operation, some systems include a centrifugal pump with a recessed impeller that minimizes the interaction between the pump impeller and the cleaning balls. This design has worked well and has proven to be a reliable solution to transfer the cleaning balls from an ATCS ball strainer discharge port or ports downstream of a condenser or heat exchanger to an injection point upstream of the equipment serviced.

Because recessed impellers are inherently less efficient than other impeller configurations, larger motors are required and a higher power consumption is experienced. The problem arises of modifying the system in some way to reduce costs associated with utilizing a centrifugal pump with a recessed impeller.

### SUMMARY OF THE INVENTION

A ball circulation pump skid comprises, in accordance with the present invention, a base frame, a pump mounted to the base frame, and a piping manifold also mounted to the base frame. The piping manifold has a first inlet and a first outlet each connected to the pump. The manifold is further provided with a second inlet and a second outlet connectable to an external device, such as a condenser or heat exchanger. The manifold houses a ball collection capsule configured to permit flow of fluid and entrained cleaning balls into the ball collection capsule in a first flow direction and to permit flow of fluid and entrained cleaning balls out of the ball collection capsule in a second flow direction. The ball collection capsule is adapted to permit flow of only fluid, without entrained cleaning balls, through the ball collection capsule in both the first flow direction and the second flow direction. A plurality of valves is mounted to the piping manifold and operative to create alternately a first fluid flow path and a second fluid flow path through the piping manifold. The first fluid flow path includes a first leg from the second inlet to the first outlet through the ball collection capsule in the first flow direction and further includes a second leg from the first inlet to the second outlet. The second fluid flow path includes a third leg from the first inlet to the second outlet through the ball collection capsule in the second flow direction and additionally includes a fourth leg from the second inlet to the first outlet.

Pursuant to a feature of the present invention, the piping manifold includes two primary conduits and three secondary conduits. Each of the three secondary conduits extends between the two primary conduits. The ball collection capsule is disposed in a first one of the three secondary conduits. The first inlet and the first outlet are located at opposite ends of a first one of the two primary conduits, while the second inlet and the second outlet are located at opposite ends of a second of the two primary conduits.

The valves preferably include a first valve in the second primary conduit between the second inlet and the first secondary conduit, a second valve in the first primary conduit between the first secondary conduit and the first outlet, a third valve in a second one of the three secondary conduits, a fourth valve in a third one of the three secondary conduits, a fifth valve in the first primary conduit between the first inlet and the first secondary conduit, and a sixth valve in the second primary conduit between the first secondary conduit and the second outlet.

The two primary conduits preferably extend horizontally, the second primary conduit being disposed vertically above the first primary conduit. The three secondary conduits preferably extend vertically in parallel to each other, the first secondary conduit being disposed between the second and the third secondary conduits.

The ball circulation pump skid may further comprise a control unit mounted to the base frame. The control unit is a numerical control unit or more preferably a microprocessor operatively connected to the pump and the valves for coordinating or synchronizing the operation and actuation thereof.

The third valve may be located in a lower end portion of the second secondary conduit, while the fourth valve is located in a lower end portion of the third secondary conduit. The manifold may be further provided with a first filter screen disposed in an upper end portion of the second secondary conduit and a second filter screen disposed in an upper end portion of the third secondary conduit. The filter screens are fastened to the respective secondary conduits, internally thereof.

Pursuant to particular features of the present invention, the ball collection capsule is provided at a first end with a perforate wall or panel configured to permit fluid passage and to prevent ball passage. The ball collection capsule is provided at a second end with at least one opening large enough to permit passage of fluid together with entrained balls alternately into and out of the ball collection capsule (depending on the phase of the operating cycle). The first flow direction extends from the second end towards the first end of the ball collection capsule, while the second flow direction extends from the first end towards the second end thereof.

Pursuant to the above description, a piping manifold for a ball circulation pump skid comprises, in accordance with the present invention, a conduit network having a first inlet and a first outlet both connectable to a pump and additionally having a second inlet and a second outlet connectable to a target device. A ball collection capsule disposed within the conduit network is provided at a first end with a perforate wall or panel configured to permit fluid passage and to prevent ball passage. The ball collection capsule is provided at a second end with at least one opening large enough to permit passage of fluid and entrained balls into and out of the ball collection capsule. Valves are mounted to the conduit network and are operative to create alternately a first fluid flow path and a second fluid flow path through the conduit network. The first fluid flow path includes a first leg from the second inlet into the ball collection capsule through the at least one opening and from the ball collection capsule through the perforate wall or panel to the first outlet. The first fluid flow path also includes a second leg from the first inlet to the second outlet. The second fluid flow path includes a third leg from the first inlet through the perforate wall or panel of the ball collection capsule and from the ball collection capsule through the at least one opening to the second outlet. The second fluid flow path additionally includes a fourth leg from the second inlet to the first outlet.

The conduit network includes the configuration of two primary conduits and three secondary conduits discussed above and the same positioning for the inlets and outlets. The valves preferably have the distribution detailed above.

A hydraulic method for use with a ball circulation pump skid comprises, pursuant to the present invention, operating a pump to move fluid through a hydraulic circuit including an operative device and a manifold of the ball circulation pump skid. During the operating of the pump, valves in the manifold are selectively actuated. The actuation of the valves is timed and coordinated to (a) direct ball-containing fluid from the operative device in a first direction through a ball collection capsule in the manifold to thereby capture balls from the fluid, (b) guide ball-free fluid from the ball collection capsule to the pump and back to the manifold, (c) direct the ball-free fluid from the pump in a second direction through the ball collection capsule to entrain the balls captured therein, and (d) move ball-entraining fluid from the ball collection capsule in the manifold to the operative device.

The directing of the ball-containing fluid from the operative device in the first direction through the ball collection capsule includes feeding the ball-containing fluid through at least one opening at one end of the ball collection capsule.

The guiding of the ball-free fluid from the ball collection capsule to the pump includes flowing the ball-free fluid through a filter screen or panel at an end of the ball collection capsule opposite the at least one opening.

The directing of the ball-free fluid from the pump in the second direction through the ball collection capsule includes moving the ball-free fluid through the filter screen or panel from a side thereof opposite the at least one opening.

The moving of the ball-entraining fluid from the ball collection capsule includes guiding cleaning balls and fluid from the capsule through the at least one opening.

Accordingly, a preferred embodiment of the present invention utilizes six valves to effectively bypass the pump, eliminating the interaction between the pump and the cleaning balls. Not only does this result in a more cost effective and efficient pump that consumes less power, but also allows the skid itself to be reduced in size dramatically. The selective opening and closing of the valves in synchronization allows the cleaning balls entering the pump skid inlet to collect in the perforated screen capsule preferably located in a central conduit of the piping manifold upstream of the pump. Free of cleaning balls, the flow continues out of the manifold to pass through the pump and ultimately exit the skid to move to the injection point upstream of the condenser or heat exchanger or other operative device. During an injection phase of an operating cycle, the flow is diverted through a small screen upstream to pass through the pump and enter the central manifold conduit. The cleaning balls collected in the previous phase of an operating cycle are entrained with the flow, exiting the manifold and traveling out of the pump skid to the injection point upstream of the equipment serviced. Not only does this flow pattern eliminate the possibility of cleaning balls interacting with the pump but allows the cleaning balls to be injected as a lot rather than continuously as in current skid designs. This solution or modification has the added benefit of increasing the cleaning efficiency of the system.

### BRIEF DESCRIPTION OF THE DRAWINGS

FIG. 1 is an isometric view of a ball circulation pump skid in accordance with the present invention.

FIG. 2 is a top plan view of the pump skid of FIG. 1.

FIG. 3 is a front elevational view of the pump skid of FIGS. 1 and 2.

FIG. 4 is a side elevational view of the pump skid of FIGS. 1-3.

FIG. 5 is a front elevational view of a central vertical conduit in the pump skid of FIGS. 1-4.

FIG. 6 is a side elevational view of the central vertical conduit of FIG. 5.

FIG. 7 is a cross-sectional view taken along line VII-VII in FIG. 4, on a larger scale.

FIG. 8 is an isometric view of a ball collection capsule housed in the central vertical conduit of FIGS. 1-7.

FIG. 9 is a side elevational view of the ball collection capsule of FIG. 8.

FIG. 10 is a cross-sectional view taken along line X-X in FIG. 9.

FIG. 11 is a top plan view of a pipe included in the pump skid of FIGS. 1-4.

FIG. 12 is a side elevational view of the pipe of FIG. 11.

FIG. 13 is an isometric view of a base frame of the pump skid of FIGS. 1-4.

### DETAILED DESCRIPTION

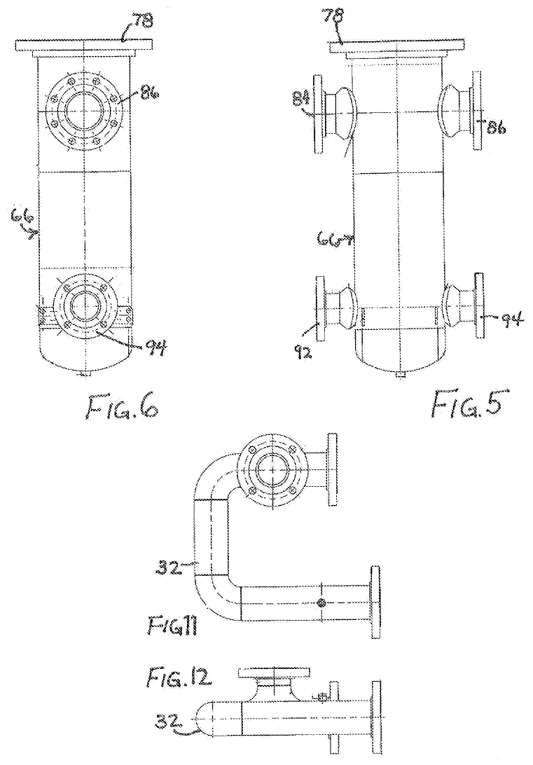

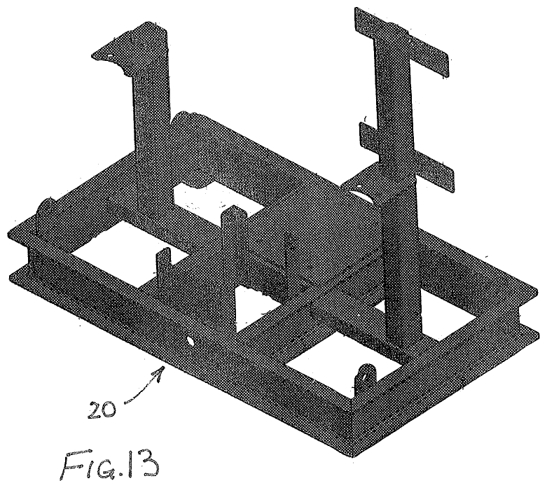

A ball circulation pump skid comprises a base frame 20, a pump 22 mounted to the base frame, and a piping manifold 24 also mounted to the base frame. Piping manifold 24 has a first inlet 26 and a first outlet 28 (FIG. 7) connected to pump 22 via respective truncated U-shape pipes 30 and 32 (FIGS. 11 and 12). Manifold 24 is further provided with a second inlet 34 and a second outlet 36 (FIG. 7) connectable to an external device (not shown), such as a condenser or heat exchanger.

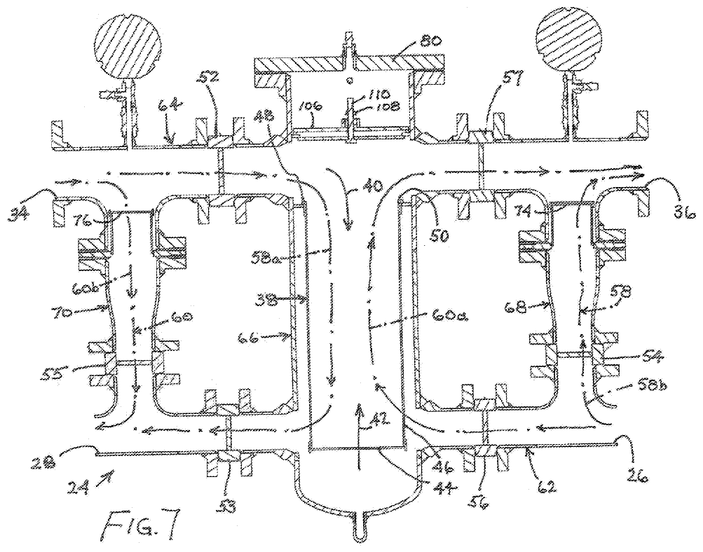

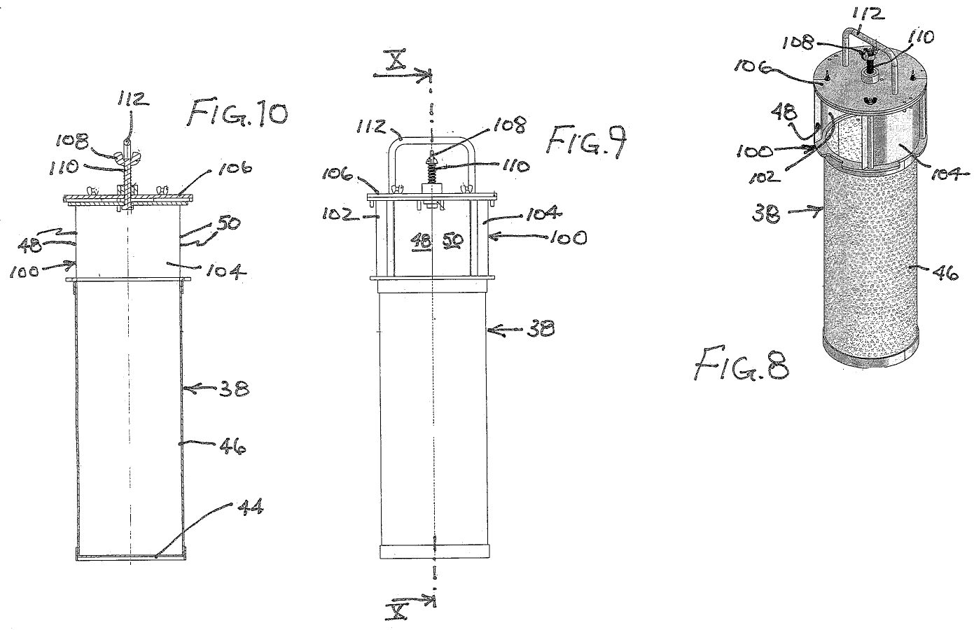

Manifold 24 houses a ball collection capsule 38 (FIGS. 7-10) configured to permit flow of fluid and entrained cleaning balls into the ball collection capsule in a first flow direction 40 (FIG. 7) and to permit flow of fluid and entrained cleaning balls out of the ball collection capsule in a second flow direction 42. Ball collection capsule 38 is adapted to permit flow of only fluid, without entrained cleaning balls, through the ball collection capsule in both the first flow direction 40 and the second flow direction 42.

Ball collection capsule 38 is provided at a lower end (not designated) with a perforate wall or panel 44 configured to permit fluid passage and to prevent ball passage. End wall or panel 44 and, optionally, a cylindrical sidewall 46 of capsule 38 are formed as screens or filter panels that block passage of cleaning balls but permit liquid flow through. Ball collection capsule 38 is provided at an upper end (not designated) with at least one opening 48 and preferably two opposed openings 48 and 50 large enough to permit passage of fluid together with entrained balls alternately into and out of the ball collection capsule (depending on the phase of the operating cycle, as described hereinafter). Flow direction 40 extends from opening 48 at the second end towards end wall or panel 44, while the second flow direction 42 extends from wall or panel 44 towards opening 50 at the top or upper end of ball collection capsule 38.

Six valves 52-57 are mounted to manifold 24 for controlling the flow of fluid therethrough. More particularly, valves 52-57 are jointly operative to create alternately a first fluid flow path 58 and a second fluid flow path 60 through the piping manifold. Flow path 58 includes a first leg 58a from inlet 34 to outlet 28 through ball collection capsule 38, overlapping the first flow direction 40, and further includes a second leg 58b from inlet 26 to outlet 36. Flow path 60 includes a leg 60a from inlet 26 to outlet 36 through ball collection capsule 38, coinciding in part with the second flow direction 42, and additionally includes a leg 60b from inlet 34 to outlet 28.

Piping manifold 24 includes two primary conduits 62 and 64 and three secondary conduits 66, 68, 70. Each of secondary conduit 66, 68, 70 extends between primary conduits 62 and 64. Ball collection capsule 38 is disposed in a first one 66 of the three secondary conduits 66, 68, 70. Inlet 26 and outlet 28 are located at opposite ends of one primary conduit 62, while inlet 34 and outlet 36 are located at opposite ends of the other primary conduit 64.

Valves 52-57 include a first valve 52 in primary conduit 64 between inlet 34 and secondary conduit 66, a second valve 53 in primary conduit 62 between secondary conduit 66 and outlet 28, a third valve 54 in a second secondary conduit 68, a fourth valve 55 in a third secondary conduit 70, a fifth valve 56 in primary conduit 62 between inlet 26 and secondary conduit 66, and a sixth valve 57 in primary conduit 64 between secondary conduit 66 and outlet 36.

The two primary conduits 62 and 64 extend horizontally, primary conduit 64 disposed vertically above primary conduit 62 and parallel thereto. Secondary conduits 66, 68, 70 preferably extend vertically in parallel to each other, secondary conduit 66 being disposed between conduits 68 and 70.

The ball circulation pump skid may further comprise a control unit 72 mounted to base frame 20. Control unit is a numerical-control unit or more preferably a microprocessor operatively connected to pump 22 and valves 52-57 for coordinating or synchronizing the operation and actuation thereof.

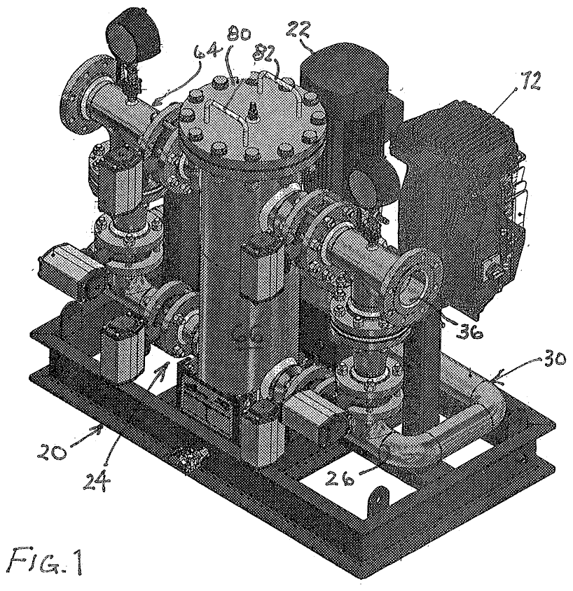

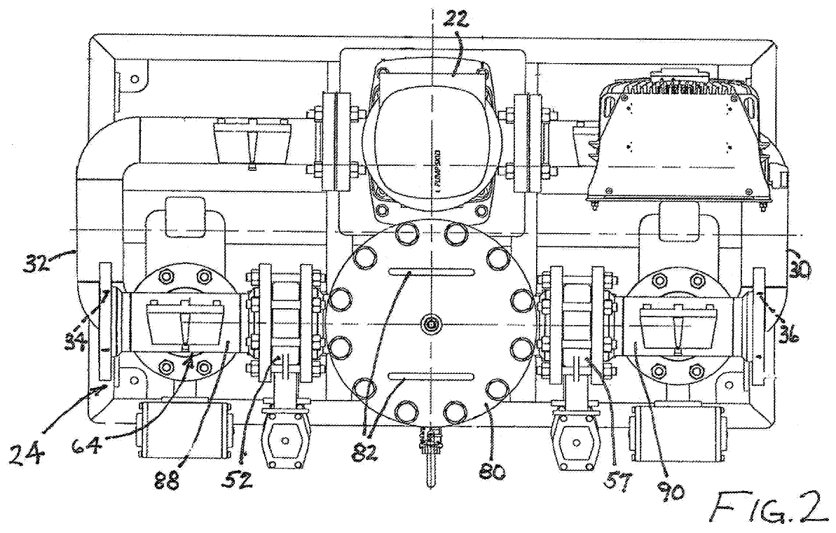

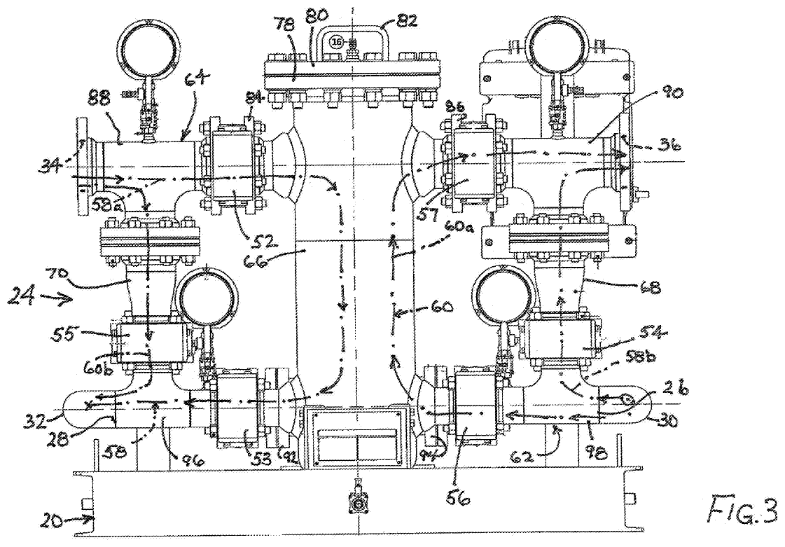

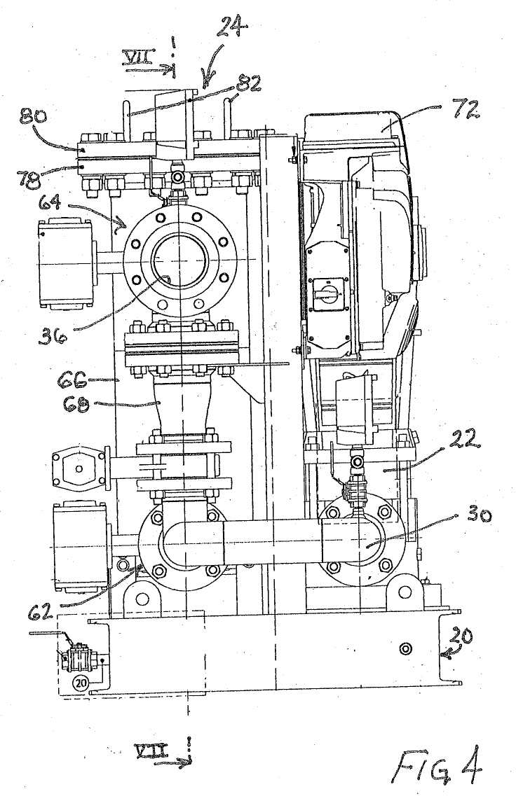

Third valve 54 is disposed in a lower end portion (not separately designated) of secondary conduit 68, while fourth valve 55 is positioned in a lower end portion (not separately designated) of secondary conduit 70. Manifold 24 further houses a filter screen 74 in an upper end portion (not separately designated) of secondary conduit 68 and a filter screen 76 in an upper end portion (not separately designated) of secondary conduit 70. Filter screens 74 and 76 are fastened to respective secondary conduits 68 and 70, internally thereof. FIGS. 5 and 6 illustrate conduit 66 as a separate part. Conduit 66 is provided at an upper end with a flange 78 to which a cover plate 80 (see also FIGS. 1-4) is bolted. Cover plate 80 is provided with a pair of handles 82 that facilitate removal of the cover plate for access to conduit 66. On opposite sides near the upper end, conduit 66 is provided with a pair of flanged ports 84 and 86 that respectively connect to valves 52 and 57 (or housings thereof, not separately designated). On sides opposite flanged ports 84 and 86, valves 52 and 57 are bolted to horizontal pipe segments 88 and 90, respectively. Upper primary conduit 64 is an assembly of flanged ports 84 and 86, the housings of valves 52 and 57 and pipe segments 88 and 90, and traverses secondary conduit 66. Similarly, opposite sides near a lower end, conduit 66 is provided with a pair of flanged ports 92 and 94 that connect to valves 53 and 56 (or non-designated housings thereof). On sides opposite flanged ports 92 and 94, valves 53 and 56 are bolted to horizontal pipe segments 96 and 98, respectively. Lower primary conduit 62 is an assembly of flanged ports 92 and 94, the housings of valves 53 and 56 and pipe segments 96 and 98, and traverses secondary conduit 66.

As depicted in FIGS. 8-10, ball collection capsule 38 includes a cap member 100 with a pair of opposed sidewalls 102 and 104 in the form of cylindrical sections that together define opening 48 on one side and opening 50 on another side. Cap member 100 is provided with a cover plate 106 removably attached to the upper end of cap member 100 via a wing nut 108 and bolt 110. A U-shaped rod 112 serves as a hand grip.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A ball circulation pump skid comprising:
a base frame;
a pump mounted to said base frame;
a piping manifold mounted to said base frame, said piping manifold having a first inlet and a first outlet each connected to said pump, said piping manifold being provided with a second inlet and a second outlet connectable to an external device;
a ball collection capsule disposed within said piping manifold, said ball collection capsule being configured to permit flow of fluid and entrained cleaning balls into said ball collection capsule in a first flow direction and to permit flow of fluid and entrained cleaning balls out of said ball collection capsule in a second flow direction, said ball collection capsule permitting flow of only fluid, without entrained cleaning balls, through said ball collection capsule in both said first flow direction and said second flow direction; and
a plurality of valves mounted to said piping manifold and operative to create alternately a first fluid flow path and a second fluid flow path through said piping manifold,
said first fluid flow path including a first leg from said second inlet to said first outlet and through said ball collection capsule in said first flow direction, said first fluid flow path including a second leg from said first inlet to said second outlet,
said second fluid flow path including a third leg from said first inlet to said second outlet through said ball collection capsule in said second flow direction, said second fluid flow path including a fourth leg from said second inlet to said first outlet.

2. The ball circulation pump skid defined in claim 1 wherein said piping manifold includes two primary conduits and three secondary conduits, each of said three secondary conduits extending between said two primary conduits, said ball collection capsule being disposed in a first one of said three secondary conduits, said first inlet and said first outlet being located at opposite ends of one of said two primary conduits, said second inlet and said second outlet being located at opposite ends of the other of said two primary conduits.

3. The ball circulation pump skid defined in claim 2 wherein said valves include:
a first valve in said other of said two primary conduits between said second inlet and said first one of said three secondary conduits;
a second valve in said one of said primary conduits between said first one of said three secondary conduits and said first outlet;
a third valve in a second one of said three secondary conduits;
a fourth valve in a third one of said three secondary conduits;
a fifth valve in said one of said primary conduits between said first inlet and said first one of said three secondary conduits; and
a sixth valve in said other of said two primary conduits between said first one of said three secondary conduits and said second outlet.

4. The ball circulation pump skid defined in claim 3 wherein said two primary conduits extend horizontally, said other of said two primary conduits being disposed vertically above said one of said two primary conduits, said three secondary conduits extending vertically in parallel to each other, said first one of said three secondary conduits being disposed between said second one and said third one of said three secondary conduits.

5. The ball circulation pump skid defined in claim 4, further comprising a control unit mounted to said base frame, said control unit being operatively connected to, said pump and said valves for coordinating the operation and actuation thereof.

6. The ball circulation pump skid defined in claim 4 wherein said third valve is located in a lower end portion of said second one of said three secondary conduits, said fourth valve being located in a lower end portion of said third one of said three secondary conduits, further comprising a first filter screen disposed in an upper end portion of said second one of said three secondary conduits and a second filter screen disposed in an upper end portion of said third one of said three secondary conduits.

7. The ball circulation pump skid defined in claim 1 wherein said ball collection capsule is provided at a first end with a perforate wall or panel configured to permit fluid passage and to prevent ball passage, said ball collection capsule being provided at a second end with at least one opening large enough to permit passage of fluid and entrained balls into and out of said ball collection capsule, said first flow direction extending from said second end towards said first end, said second flow direction extending from said first end towards said second end.

8. A piping manifold for a ball circulation pump skid, comprising:
a conduit network having a first inlet and a first outlet both connectable to a pump, said conduit network being provided with a second inlet and a second outlet connectable to a target device;
a ball collection capsule disposed within said conduit network, said ball collection capsule being provided at a first end with a perforate wall or panel configured to permit fluid passage and to prevent ball passage, said ball collection capsule being provided at a second end with at least one opening large enough to permit passage of fluid and entrained balls into and out of said ball collection capsule; and
a plurality of valves mounted to said conduit network and operative to create alternately a first fluid flow path and a second fluid flow path through said conduit network,
said first fluid flow path including a first leg from said second inlet into said ball collection capsule through said at least one opening and from said ball collection capsule through said perforate wall or panel to said first outlet, said first fluid flow path including a second leg from said first inlet to said second outlet,
said second fluid flow path including a third leg from said first inlet through said perforate wall or panel of said ball collection capsule and from said ball collection capsule through said at least one opening to said second outlet, said second fluid flow path including a fourth leg from said second inlet to said first outlet.

9. The piping manifold defined in claim 8 wherein said conduit network includes two primary conduits and three secondary conduits, each of said three secondary conduits extending between said two primary conduits, said ball collection capsule being disposed in a first one of said three secondary conduits, said first inlet and said first outlet being located at opposite ends of one of said two primary conduits, said second inlet and said second outlet being located at opposite ends of the other of said two primary conduits.

10. The piping manifold defined in claim 9 wherein said valves include:
a first valve in said other of said two primary conduits between said second inlet and said first one of said three secondary conduits;
a second valve in said one of said primary conduits between said first one of said three secondary conduits and said first outlet;
a third valve in a second one of said three secondary conduits;
a fourth valve in a third one of said three secondary conduits;
a fifth valve in said one of said primary conduits between said first inlet and said first one of said three secondary conduits; and
a sixth valve in said other of said two primary conduits between said first one of said three secondary conduits and said second outlet.

11. The piping manifold defined in claim 10, further comprising a base frame defining a horizontal base, said conduit network and said pump being mounted to said base frame, said two primary conduits extending horizontally with said other of said two primary conduits disposed vertically above said one of said two primary conduits, said three secondary conduits extending vertically in parallel to each other, said first one of said three secondary conduits being disposed between said second one and said third one of said three secondary conduits.

12. The piping manifold defined in claim 10 wherein said third valve is located in a lower end portion of said second one of said three secondary conduits, said fourth valve being located in a lower end portion of said third one of said three secondary conduits, further comprising a first filter screen disposed in an upper end portion of said second one of said three secondary conduits and a second filter screen disposed in an upper end portion of said third one of said three secondary conduits.

13. A hydraulic method for use with a ball circulation pump skid, comprising:
operating a pump to move fluid through a hydraulic circuit including an operative device and a manifold of the ball circulation pump skid;
during the operating of said pump, selectively actuating valves in said manifold; and
by virtue of the selective actuation of said valves:
(a) directing ball-containing fluid from said operative device in a first direction through a ball collection capsule in said manifold to thereby capture balls from the fluid,
(b) guiding ball-free fluid from said ball collection capsule to said pump and back to said manifold,
(c) directing the ball-free fluid from said pump in a second direction through said ball collection capsule to entrain the balls captured therein, and
(d) moving ball-entraining fluid from said ball collection capsule in said manifold to said operative device.

14. The method defined in claim 13 wherein the directing of said ball-containing fluid from said operative device in said first direction through said ball collection capsule includes feeding said ball-containing fluid through at least one opening at one end of said ball collection capsule.

15. The method defined in claim 14 wherein the guiding of said ball-free fluid from said ball collection capsule to said pump includes flowing said ball-free fluid through a filter screen or panel at an end of said ball collection capsule opposite said at least one opening.

16. The method defined in claim 15 wherein the directing of the ball-free fluid from said pump in said second direction through said ball collection capsule includes moving said ball-free fluid through said filter screen or panel from a side thereof opposite said at least one opening.

17. The method defined in claim 16 wherein the moving of the ball-entraining fluid from said ball collection capsule includes guiding cleaning balls and fluid from said capsule through said at least one opening.

18. The method defined in claim 13 wherein said second direction is opposite said first direction.
